(19) United States
(12) Patent Application Publication
(10) Pub. No.: US 2022/0312845 A1
(43) Pub. Date: Oct. 6, 2022

(54) Aerosol generating device

(71) Applicant: SHENZHEN FIRST UNION TECHNOLOGY CO.,LTD., Shenzhen (CN)

(72) Inventors: Peixia Yu, Shenzhen (CN); Ruilong Hu, Shenzhen (CN); Yonghai Li, Shenzhen (CN); Zhongli Xu, Shenzhen (CN)

(21) Appl. No.: 17/844,102

(22) Filed: Jun. 20, 2022

Related U.S. Application Data
(63) Continuation of application No. PCT/CN2020/137720, filed on Dec. 18, 2020.

(30) Foreign Application Priority Data
Dec. 20, 2019 (CN) 201911324483.X

(51) Int. Cl. A24F 40/46; H05B 3/00; H05B 3/42; A24F 40/20

(52) U.S. Cl. CPC A24F 40/46; H05B 3/0038; H05B 3/42; A24F 40/20; H05B 2203/032

(57) ABSTRACT

An aerosol generating device including a housing of which is provided therein with a cavity for receiving a smokable material; a holding mechanism for holding the smokable material in the cavity along the radial direction and an infrared emitter located outside the cavity along the radial direction to radiate infrared rays to heat the smokable material. A distance between an inner surface of the infrared emitter and the central axis of the cavity is larger than the shortest distance between the holding mechanism and the central axis of the cavity, so that a certain space is maintained between the smokable material and the inner surface of the infrared emitter when the smokable material is received in the cavity, thereby preventing the infrared emitter from heating the smokable material by contact conduction.

### CROSS-REFERENCE TO RELATED APPLICATION

The present application is based upon and claims priority to Chinese Patent Application No. 201911324483.X, filed with the Chinese Patent Office on Dec. 20, 2019, titled “AEROSOL GENERATING DEVICE”, the entire content of which is incorporated herein by reference.

### TECHNICAL FIELD

Embodiments of the present application relate to the field of smoking sets which are noncombustible when being heated, and in particular, relate to an aerosol generating device.

### BACKGROUND

Tobacco products (e.g., cigarettes, cigars, etc.) burn tobacco to produce tobacco smoke during use. Attempts have been made to replace these tobacco-burning products by manufacturing products that release compounds without burning.

An example of such products is a heating device, which release compounds by heating instead of burning a material. For example, the material may be tobacco or other non-tobacco products, and these non-tobacco products may or may not contain nicotine. As another example, there is a heating device that heats a tobacco product around the circumference thereof so that the tobacco product releases a compound to generate an aerosol. For example, Chinese Patent Application No. 201780028361.9, which is a known technology, uses a tubular resistance or thin film heater to heat the tobacco product received in the tubular hollow space.

### SUMMARY

In an aspect, the embodiment of the present application discloses an aerosol generating device for heating a smokable material to generate aerosol for smoking. The aerosol generating device includes a housing. The housing is provided therein with: a cavity, being configured to receive a smokable material; an infrared emitter, being in a tubular shape which is around the cavity and extended along the axial direction of the cavity; wherein the infrared emitter is configured to radiate infrared rays to the smokable material received in the cavity to heat the smokable material; a holding mechanism arranged around the cavity; wherein the holding mechanism is configured to support the smokable material received in the cavity in the radial direction of the cavity to prevent the movement of the smokable material in the radial direction of the cavity; wherein in the radial direction of the cavity, a distance between an inner surface of the infrared emitter and the central axis of the cavity is larger than the shortest distance between the holding mechanism and the central axis of the cavity, so that a space is maintained between the smokable material and the inner surface of the infrared emitter when the smokable material is received in the cavity.

Optionally, the distance between the inner surface of the infrared emitter and the central axis of the cavity is 0.5 mm to 10 mm larger than the shortest distance between the holding mechanism and the central axis of the cavity.

Optionally, the housing is further provided therein with a first support which at least partially extends into the cavity in the radial direction, and the first support is configured to abut against the smokable material abuts in the axial direction when the smokable material is received in the cavity, thereby providing locking for the smokable material in the axial direction of the cavity.

Optionally, the holding mechanism includes an extension part extending from the first support into the infrared emitter, and the extension part is arranged in an annular shape around the cavity; the extension part has an inner diameter smaller than that of the infrared emitter, and the extension part is configured to abut against the outer surface of the smokable material received in the cavity in the radial direction, thereby preventing the movement of the smokable material in the radial direction of the cavity and forming the space.

Optionally, at least a part of the inner surface of the extension part is an inclined surface that inclines inward radially, and the smokable material at least partially abuts against the first support under the guidance of the inner surface of the extension part.

Optionally, the infrared emitter includes a first end and a second end which are opposite along the length direction; the holding mechanism includes a second support that supports or holds the infrared emitter at the first end or the second end; the second support is in an annular shape coaxially arranged with the infrared emitter; the second support has an inner diameter smaller than that of the infrared emitter, and the second support is configured to abut against the outer surface of the smokable material received in the cavity in the radial direction, thereby preventing the movement of the smokable material in the radial direction of the cavity and forming the space.

Optionally, the infrared emitter includes a first end and a second end which are opposite along the length direction; the housing is provided therein with a second support that supports or holds the infrared emitter at the first end or the second end; the holding mechanism includes a plurality of flanges extending from the second support along the radial direction of the cavity, and the flanges are arranged around the central axis of the cavity; the shortest distance between the flange and the central axis of the cavity in the radial direction of the cavity is smaller than the distance between the inner surface of the infrared emitter and the central axis of the cavity, and the flanges are configured to abut against the outer surface of the smokable material received in the cavity in the radial direction, thereby preventing the movement of the smokable material in the radial direction of the cavity and forming the space.

Optionally, the flanges are inclined inward radially to guide the smokable material when the smokable material is received in the cavity.

Optionally, the housing includes a proximal end and a distal end which are opposite along the length direction; wherein the proximal end is provided with a receiving hole through which the smokable material is capable of being received in or removed from the cavity; the distal end is provided with an air inlet opposite to the receiving hole; the first end of the infrared emitter is opposite to the receiving hole, and the second end thereof is opposite to the air inlet; the second support is configured to support or hold the annular shape of the infrared emitter at the second end; the housing is further provided therein with a tubular element positioned between the air inlet and the second support; the hollow space of the tubular element and the second support is arranged as an airflow path from the air inlet to the cavity.

Optionally, the housing is provided therein with a tubular base extending along the axial direction of the cavity and surrounding the cavity; the infrared emitter includes an infrared emission coating formed on an outer surface of the tubular base; the holding mechanism includes a portion of the tubular base with a reduced inner diameter, and the holding mechanism abuts against the outer surface of the smokable material received in the cavity through the portion with the reduced inner diameter, thereby preventing the movement of the smokable material in the radial direction of the cavity and forming the space.

### BRIEF DESCRIPTION OF THE DRAWINGS

One or more embodiments are illustrated by pictures in corresponding attached drawings, and this does not constitute limitation on the embodiments. Elements with the same reference numerals in the attached drawings are shown as similar elements, and the pictures in the attached drawings do not constitute scale limitation unless otherwise stated specifically.

FIG. 1 is a schematic view of an aerosol generating device in use, according to an embodiment.

FIG. 2 is a schematic view of the aerosol generating device in FIG. 1 from another viewing angle.

FIG. 3 is a schematic view illustrating the internal structure of the aerosol generating device in FIG. 1.

FIG. 4 is a schematic cross-sectional view of the aerosol generating device in FIG. 3 taken along the width direction.

FIG. 5 is a schematic cross-sectional view illustrating the structure of a heating mechanism in FIG. 4 taken along the width direction.

FIG. 6 is a schematic cross-sectional view illustrating the perspective structure of the heating mechanism in FIG. 4.

FIG. 7 is a schematic structural diagram of an infrared emitter in FIG. 4.

FIG. 8 is a schematic view illustrating the assembly relationship between an upper bracket and a lower bracket of the smokable material in FIG. 4 with.

FIG. 9 is a perspective cross-sectional view of the upper bracket in FIG. 8 from a viewing angle.

FIG. 10 is a perspective cross-sectional view of the lower bracket in FIG. 8 from a viewing angle.

FIG. 11 is a schematic cross-sectional view of an infrared emitter according to another embodiment.

### DETAILED DESCRIPTION

In order to make the objectives, technical solutions and advantages of the embodiments of the present application clearer, the technical solutions in the embodiments of the present application will be clearly and completely described below with reference to the attached drawings in the embodiments of the present application. Obviously, the embodiments described are only part but not all of the embodiments of the present application. It shall be appreciated that, the specific embodiments described herein are only used for explaining the present application, and are not intended to limit the present application. Based on the embodiments in the present application, all other embodiments obtained by those of ordinary skill in the art without creative labor belong to the scope claimed in the present application.

It shall be noted that, when an element is expressed as “fixed” to another element, it may be directly on another element, or there may be one or more intervening elements therebetween. When an element is expressed as “connected” to another element, it may be directly connected to another element, or there may be one or more intervening elements therebetween. Terms such as “vertical”, “horizontal”, “left”, “right” and other similar expressions used in this specification are for illustration purposes only.

In addition, technical features involved in various embodiments of the present application described below can be combined with each other as long as they do not conflict with each other.

An embodiment of the present application provides an aerosol generating device for heating instead of burning a smokable material, such as cigarettes, so as to volatilize or release at least one component of the smokable material to form aerosol for smoking.

Based on a preferred embodiment, the aerosol generating device heats the smokable material by radiating far infrared rays with the heating effect e.g., far infrared rays of 3 μm to 15 μm. When the wavelength of the infrared rays matches the absorption wavelength of the volatile component of the smokable material during use, the energy of the infrared rays is easily absorbed by the smokable material, and then the smokable material is heated to volatilize at least one volatile component thereof to generate aerosol for smoking.

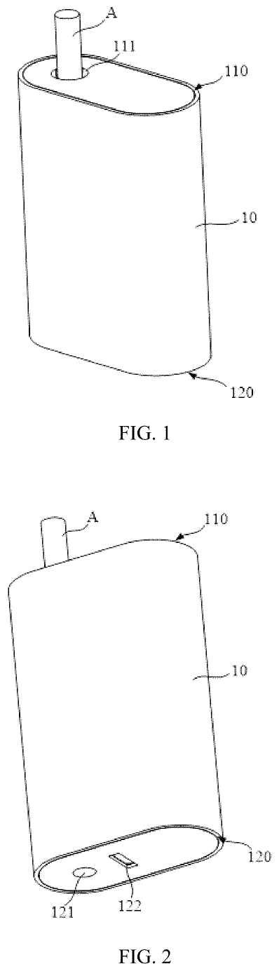

Reference may be made to FIG. 1 to FIG. 2 for the structure of an aerosol generating device according to an embodiment of the present application. The overall shape of the device is generally configured in a flat cylinder shape, and external components of the aerosol generating device include: a housing 10, the interior of which is hollow to form an assembly space for accommodating necessary functional components such as infrared radiation; the housing 10 has a proximal end 110 and a distal end 120 which are opposite along the length direction; wherein the proximal end 110 is provided with a receiving hole 111 through which the smokable material A can be received in the housing 10 to be heated or removed from the housing 10; the distal end 120 is provided with an air inlet 121 and a charging interface 122; the air inlet 121 is used to allow outside air to enter the housing 10 during smoking; and the charging interface 122, such as a USB type-C interface, a Pin type interface or the like, is used for charging the aerosol generating device by being connected to an external power supply or adapter.

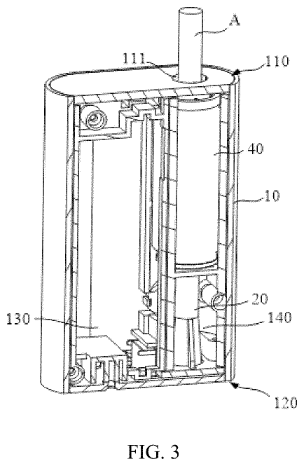

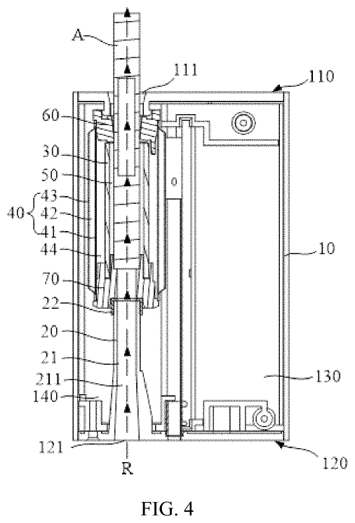

Further, the internal structure of the housing 10 is as shown in FIG. 3 and FIG. 4, and it includes a first compartment 130 and a second compartment 140 which are sequentially arranged in the width direction. The first compartment 130 is an installation space for installing electronic devices such as electrical cores and circuit boards (not shown in the figure), while the second compartment 140 is an installation space for installing and holding a heating mechanism.

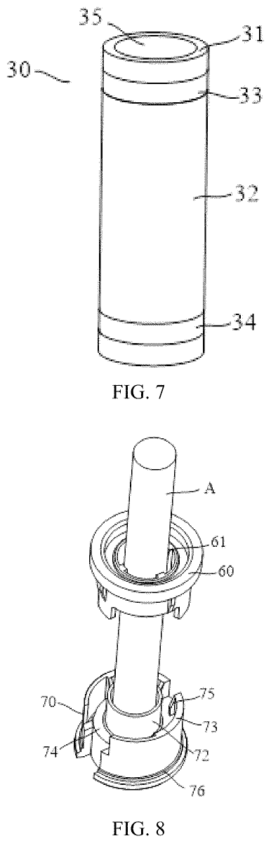

As shown in FIG. 4, the heating mechanism includes: an infrared emitter 30 arranged in the second compartment 140 along the length direction of the housing 10, and the perspective structure thereof may be as shown in FIG. 7; wherein the infrared emitter 30 includes: a tubular base 31, which, as a rigid carrier and an object containing the smokable material A, may be made of high-temperature resistant and infrared-transmitting materials such as quartz glass, ceramics or mica in an embodiment. Alternatively, the tubular base 31 is made of a transparent material, for example, a high-temperature resistant material with infrared transmittance above 95%; and the interior space of the tubular base 31 forms a cavity 35 for containing and heating the smokable material A; an infrared emission coating 32 provided on at least a part of the outer surface of the tubular base 31, wherein the infrared emission coating 32 is an electro-infrared emission coating, and it can generate heat by itself when energized and radiate infrared rays which can be used to heat the smokable material A, such as the above-mentioned far infrared rays of 3 μm to 15 μm, to the smokable material received in the cavity 35. When the wavelength of the infrared rays matches the absorption wavelength of the volatile component of the smokable material A, the energy of infrared rays is easily absorbed by the smokable material A.

In an embodiment, the infrared emission coating 32 may be a coating made of ceramic-based materials such as zirconium, or Fe—Mn—Cu-based materials, tungsten-based materials, or transition metals and oxides thereof.

In another embodiment, the infrared emission coating 32 is preferably composed of oxides of at least one metal element such as Mg, Al, Ti, Zr, Mn, Fe, Co, Ni, Cu, Cr or the like. These metal oxides will radiate the above-mentioned far infrared rays with the heating effect when heated to a proper temperature. Alternatively, the thickness of the infrared emission coating 32 may be controlled to be 30 μm to 50 μm. The infrared emission coating 32 may be formed on the surface of the base 31 by spraying the oxides of the above metal elements on the outer surface of the base 31 by atmospheric plasma spraying and then curing the oxides.

Alternatively, the infrared emission coating 32 may also be formed on the inner surface of the base 32.

The infrared emitter 30 further includes a first conductive coating 33 and a second conductive coating 34 respectively formed on at least a part of the outer surfaces of the opposite ends of the infrared emission coating 32. According to the embodiment shown in FIG. 7, the first conductive coating 33 and the second conductive coating 34 are both in annular shape and are in contact with the infrared emission coating 32. During use, the first conductive coating 33 and the second conductive coating 34 may be electrically connected to the anode and cathode of a power supply respectively, so that the infrared emission coating 32 generates heat electrically and radiates infrared rays. The first conductive coating 33 and the second conductive coating 34 may be conductive coatings formed by dipping or coating, and usually, the first conductive coating 33 and the second conductive coating 34 may include silver, gold, palladium, platinum, copper, nickel, molybdenum, tungsten, niobium or metals or alloys thereof.

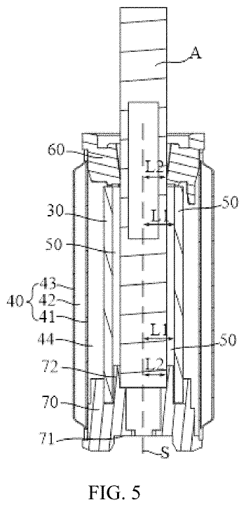

In the embodiment shown in FIG. 4 and FIG. 5, in order to prevent the gelatinization of the outer wrapping paper of the smokable material A, the inner diameter of the tubular base 31 is configured to be larger than the outer diameter of the smokable material A, so that when the smokable material A is received in the cavity 35, the smokable material A is not in contact with the inner surface of the tubular base 31 and a certain space 50 is maintained therebetween. In this way, generally the smokable material A is heated only by absorbing the energy of the infrared rays during use, thereby avoiding the generation of a burnt taste caused by the gelatinization of the outer wrapping paper of the smokable material A due to the heat conduction of the tubular base 31 to the outer wrapping paper of the smokable material A, and meanwhile eliminating the premature or excessive carbonization of the aerosol-forming base material in the smokable material A under the double effects of heat conduction and infrared radiation.

In an embodiment, the size or thickness of the space 50 in the radial direction is preferably controlled to be 0.5 mm to 10 mm, and in another embodiment, the size of the space 50 in the radial direction is controlled to be 3 mm to 5 mm in order to make the size and thickness of the housing 10 appropriate to the infrared radiation range.

Further referring to FIG. 4 and FIG. 5, the heating mechanism further includes a heat insulator 40 located outside the infrared emitter 30 in the radial direction, the heat insulator 40 is in tubular shape and includes an inner tube wall 41 and an outer tube wall 43 which are sequentially arranged from inside to outside in the radial direction, and a central area 42 located between the inner tube wall 41 and the outer tube wall 43. In an embodiment, the inner tube wall 41 and the outer tube wall 43 may be made of rigid materials, such as stainless steel, ceramic, PPEK or the like, and the pressure of the central area 42 is configured to be lower than the pressure outside the heat insulator 40. That is, the central area 42 has or forms a certain degree of vacuum so as to reduce the radial outward conduction of the heat generated by the infrared emitter 30 in operation.

In an embodiment, a certain interval is maintained between the inner tube wall 41 of the heat insulator 40 and the infrared emitter 30 to form an air dielectric layer 44, which may further promote the heat insulation by the low heat conductivity coefficient of air.

Further referring to the embodiment shown in FIG. 4, in an embodiment, the second compartment 140 is further provided therein with a tubular element 20 located in front of the heating mechanism and the air inlet 122 along the length direction, and the tubular element 20 is used to enable airflow communication between the cavity 35 and the air inlet 122 during smoking. As shown by an arrow R in FIG. 4, during smoking, the outside air enters the housing 10 through the air inlet 122, enters the cavity 35 through the inner hollow space 21 of the tubular element 20, and then passes through the smokable material A to be inhaled by the user.

In addition, further referring to FIG. 4, the inner diameter of the inner hollow space 21 of the above-mentioned tubular element 20 is not constant, but has a portion 211 that gradually decreases along the direction from the air inlet 122 to the cavity 35.

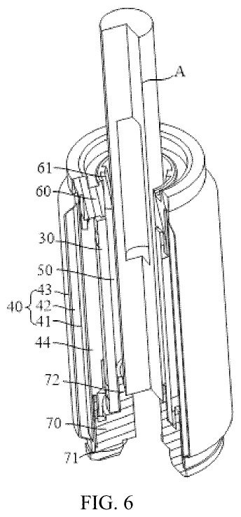

Further referring to FIG. 4 to FIG. 6, in order to ensure the stable fixation of the infrared emitter 30 and the heat insulator 40 in the housing 10, and to provide support for the smokable material A so that the smokable material A is fixed instead of being movable in the radial direction of the cavity 35 so as to form and maintain a space 50 between the outer surface of the fixed smokable material A and the inner surface of the infrared emitter 30, the housing 10 is further provided therein with an upper support 60 and a lower support 70, and both the upper support 60 and the lower support 70 are generally designed in a hollow annular shape. Specifically, the lower surface of the lower support 70 is provided with an insertion groove 71, and the upper end of the tubular element 20 is inserted into the insertion groove 71 so that the lower support 70 itself is stably supported and held in the housing 10. Further referring to FIG. 4 to FIG. 6, the insertion groove 71 is a columnar space coaxial with the hollow space of the lower support 70, and the diameter of the insertion groove 71 is larger than that of the hollow space of the lower support 70 so that the upper end of the tubular element 20 abuts against the insertion groove 71.

Furthermore, in an embodiment shown in FIG. 4, in order to ensure the airtightness after the lower support 70 is joined with the tubular element 20, a sealing ring 22 made of a flexible material such as silica gel or polyimide is arranged in the gap at the joint between the tubular element 20 and the insertion groove 71.

Reference may be made to FIG. 8 and FIG. 10 for the support of the lower support 70 for the infrared emitter 30 and the heat insulator 40 and the assembly relationship therebetween. The lower support 70 is provided thereon with a first boss 74 and a second boss 76 arranged from inside to outside in the radial direction. The first boss 74 is used for abutting against the lower end of the infrared emitter 30, and the second boss 76 is used for abutting against the lower end of the heat insulator 40. The lower support 70 is further provided with an annular extension part 72 that extends at least partially into the cavity 35 of the infrared emitter 30, and the annular extension part 72 is used to provide an interval to prevent the outer surface of the smokable material A from contacting the inner surface of the cavity 35 when the smokable material A is received in the cavity 35, thereby forming the above-mentioned space 50.

As shown in FIG. 8 and FIG. 10, in an embodiment, the annular extension part 72 is further provided with a third boss 77, and the diameter of the third boss 77 is smaller than the outer diameter of the smokable material A so that the smokable material A can abut against the third boss 77 to form locking. Meanwhile, the inner surface of the annular extension part 72 is provided as an inclined surface that inclines inward in the direction from top to bottom so as to provide guidance when the smokable material A is inserted into and abuts against the third boss 77. In addition, further referring to FIG. 4, the third boss 77 extends into the cavity 35 when installed.

Similarly, in an embodiment shown in FIG. 8 and FIG. 10, the lower support 70 is further provided thereon with a first guide portion 75 which provides guidance when the infrared emitter 30 is inserted into and abuts against the first boss 74; and a second annular extension part 72 for guiding and supporting the heat insulator 40 when the heat insulator 40 abuts against the second boss 76.

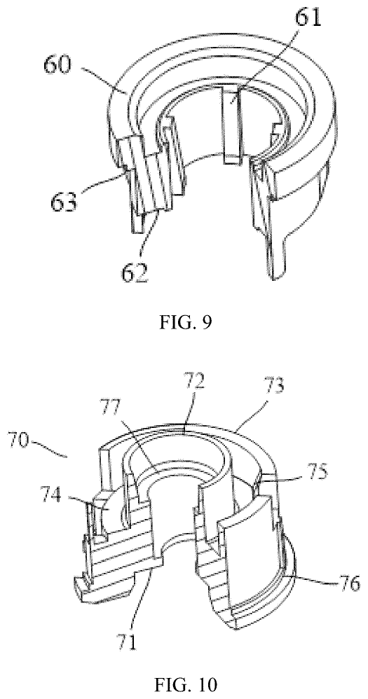

Further referring to FIG. 8 and FIG. 9 for the structure of the upper support 60, the upper support 60 is provided thereon with a fourth boss 62 and a fifth boss 63 respectively abutting against the upper ends of the infrared emitter 30 and the heat insulator 40. Furthermore, the upper support 60 is further provided thereon with a plurality of flanges 61 located in the annular hollow space, and as can be seen from the figures, the plurality of flanges 61 are arranged at intervals around the circumference of the smokable material A, and the flanges 61 are designed to be inclined from top to bottom so as to provide guidance when inserting the smokable material A into the cavity 35. Moreover, the flanges 61 abut against and clamp the outer surface of the smokable material A to prevent the movement of the smokable material A along the radial direction of the cavity 35.

Furthermore, according to the above embodiment, the structures for stably holding the smokable material A in the cavity 35 along the radial direction may be realized by the flange 61 provided on the inner surface of the upper support 60 and the inner surface of the annular extension part 72 of the lower support 70 respectively, and both the flange 61 and the inner surface of the annular extension part 72 can abut against and clamp the outer surface of the smokable material A in the radial direction. Meanwhile, as shown in FIG. 5, the size of the inner diameter of the annular extension part 72 is smaller than the inner diameter of the infrared emitter 30, and a distance L2 between the flange 61 and the central axis S of the cavity 35 in the radial direction is smaller than a distance L1 between the inner surface of the infrared emitter 30 and the central axis S of the cavity 35, so that the space 50 is stably formed and maintained between the smokable material A and the inner surface of the infrared emitter 30, thereby avoiding contact conduction.

In other similar embodiments, it is also possible to adopt additional or independent annular or clamping structures or components arranged around the outer surface of the smokable material A to implement the above holding function.

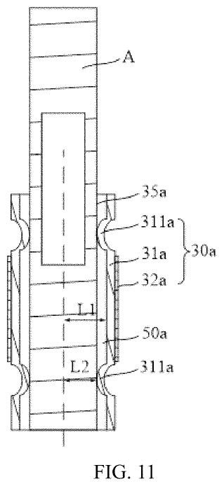

For example, in yet another embodiment shown in FIG. 11, the holding function is realized by the inner wall of the tubular base 31a of the infrared emitter 30a. Specifically, referring to FIG. 11, the aerosol generating device according to this embodiment includes a tubular base 31a, the tubular base 31a surrounds a cavity 35a for receiving the smokable material A or a part of space of the tubular base 31a forms the cavity 35a for receiving the smokable material A; and the infrared emitter includes an infrared emission coating 32a formed on the outer surface of the tubular base 31a; and the inner wall of the tubular base 31a is provided thereon with a portion 311a bent towards the interior of the cavity 35a with a reduced inner diameter. The portion 311a with the reduced inner diameter abuts against and clamps the smokable material A to form a structure for stably holding the smokable material A in the cavity 35a along the radial direction. As shown in FIG. 11, the infrared emission coating 32a is located between two portions 311a with reduced inner diameters in the axial direction. Therefore, the distance L2 between the portion 311a with the reduced inner diameter and the central axis S of the cavity 35a in the radial direction is smaller than the distance L1 between the inner surface portion 312a opposite to the infrared emission coating 32a and the central axis S, so that a space 50a is formed and maintained between the inner surface portion 312a and the smokable material A.

It shall be noted that, the specification and attached drawings of the present application show preferred embodiments of the present application. However, the present application can be implemented in many different forms, and it is not limited to the embodiments described in this specification. These embodiments are not construed as additional restrictions on the content of the present application, but are provided for a more thorough and comprehensive understanding of the disclosure of the present application. In addition, the above technical features continue to be combined with each other to form various embodiments not listed above, all of which are regarded as within the scope described in the specification of the present application. Further speaking, those of ordinary skill in the art can make improvements or variations according to the above description, and all these improvements and variations shall fall within the scope claimed in the appended claims of the present application.

What is claimed is:

1. An aerosol generating device for heating a smokable material to generate aerosol for smoking, comprising a housing; wherein the housing is provided therein with:
a cavity, being configured to receive the smokable material;
an infrared emitter, being in a tubular shape which is around the cavity and extended along the axial direction of the cavity; wherein the infrared emitter is configured to radiate infrared rays to the smokable material received in the cavity to heat the smokable material;
a holding mechanism arranged around the cavity; wherein the holding mechanism is configured to support the smokable material received in the cavity in the radial direction of the cavity to prevent the movement of the smokable material in the radial direction of the cavity;
wherein in the radial direction of the cavity, a distance between an inner surface of the infrared emitter and the central axis of the cavity is larger than the shortest distance between the holding mechanism and the central axis of the cavity, so that a space is maintained between the smokable material and the inner surface of the infrared emitter when the smokable material is received in the cavity.

2. The aerosol generating device according to claim 1, wherein the distance between the inner surface of the infrared emitter and the central axis of the cavity is 0.5 mm to 10 mm larger than the shortest distance between the holding mechanism and the central axis of the cavity.

3. The aerosol generating device according to claim 1, wherein the housing is further provided therein with a first support which at least partially extends into the cavity in the radial direction, and
the first support is configured to abut against the smokable material in the axial direction when the smokable material is received in the cavity, thereby providing locking for the smokable material in the axial direction of the cavity.

4. The aerosol generating device according to claim 3, wherein the holding mechanism comprises an extension part extending from the first support into the infrared emitter, and the extension part is arranged in an annular shape around the cavity;
wherein the extension part has an inner diameter smaller than that of the infrared emitter, and the extension part is configured to abut against the outer surface of the smokable material received in the cavity in the radial direction, thereby preventing the movement of the smokable material in the radial direction of the cavity and forming the space.

5. The aerosol generating device according to claim 4, wherein at least a part of the inner surface of the extension part is an inclined surface that inclines inward radially, and the smokable material at least partially abuts against the first support under the guidance of the inner surface of the extension part.

6. The aerosol generating device according to claim 1, wherein the infrared emitter comprises a first end and a second end which are opposite along the length direction; and
the holding mechanism comprises a second support that supports or holds the infrared emitter at the first end or the second end; wherein the second support is in an annular shape coaxially arranged with the infrared emitter; the second support has an inner diameter smaller than that of the infrared emitter, and the second support is configured to abut against the outer surface of the smokable material received in the cavity in the radial direction, thereby preventing the movement of the smokable material in the radial direction of the cavity and forming the space.

7. The aerosol generating device according to claim 1, wherein the infrared emitter comprises a first end and a second end which are opposite along the length direction;
the housing is provided therein with a second support that supports or holds the infrared emitter at the first end or the second end; and
the holding mechanism comprises a plurality of flanges extending from the second support along the radial direction of the cavity, and the flanges are arranged around the central axis of the cavity; wherein the shortest distance between the flange and the central axis of the cavity in the radial direction of the cavity is smaller than the distance between the inner surface of the infrared emitter and the central axis of the cavity, and the flanges are configured to abut against the outer surface of the smokable material received in the cavity in the radial direction, thereby preventing the movement of the smokable material in the radial direction of the cavity and forming the space.

8. The aerosol generating device according to claim 7, wherein the flanges are inclined inward radially to guide the smokable material when the smokable material is received in the cavity.

9. The aerosol generating device according to= claim 6, wherein the housing comprises a proximal end and a distal end which are opposite along the length direction;
wherein the proximal end is provided with a receiving hole through which the smokable material is capable of being received in or removed from the cavity; the distal end is provided with an air inlet opposite to the receiving hole;
the first end of the infrared emitter is opposite to the receiving hole, and the second end of the infrared emitter is opposite to the air inlet; the second support is in an annular shape for supporting or holding the infrared emitter at the second end;
wherein the housing is further provided therein with a tubular element positioned between the air inlet and the second support;
a hollow space of the tubular element and the second support is arranged as an airflow path from the air inlet to the cavity.

10. The aerosol generating device according to claim 9, wherein the hollow space of the tubular element comprises a portion whose inner diameter gradually decreases along the direction from the air inlet to the cavity.

11. The aerosol generating device according to claim 9, wherein the second support is provided with an insertion groove, and the tubular element is inserted into the insertion groove so that the second support is stably supported and held in the housing.

12. The aerosol generating device according to claim 11, wherein the insertion groove is a columnar space coaxial with the hollow space of the second support, and a diameter of the insertion groove is larger than a diameter of the hollow space of the second support so that the tubular element abuts against the insertion groove.

13. The aerosol generating device according to claim 11, wherein a sealing ring made of a flexible material is arranged in a gap between the tubular element and the insertion groove.

14. The aerosol generating device according to claim 1, wherein the housing is provided therein with a tubular base extending along the axial direction of the cavity and surrounding the cavity;
the infrared emitter comprises an infrared emission coating provided on an outer surface of the tubular base;
the holding mechanism comprises a portion of the tubular base with a reduced inner diameter, and the holding mechanism abuts against the outer surface of the smokable material received in the cavity through the portion with the reduced inner diameter, thereby preventing the movement of the smokable material in the radial direction of the cavity and forming the space.

15. The aerosol generating device according to claim 1, wherein the infrared emitter comprises:
a tubular base forming the cavity for containing and heating the smokable material;
an infrared emission coating provided on at least a part of surface of the tubular base.

16. The aerosol generating device according to claim 15, wherein the infrared emitter further comprises:
a first conductive coating provided on at least a part of surfaces of the tubular base;
a second conductive coating provided on at least a part of surfaces of the tubular base
wherein the first conductive coating and the second conductive coating are located on the opposite ends of the infrared emission coating; the first conductive coating and the second conductive coating are both in annular shape and in contact with the infrared emission coating.

17. The aerosol generating device according to claim 1, wherein the housing is further provided therein with a heat insulator located outside the infrared emitter in the radial direction.

18. The aerosol generating device according to claim 17, wherein the heat insulator is in tubular shape and comprises an inner tube wall and an outer tube wall which are sequentially arranged from inside to outside in the radial direction, and a central area located between the inner tube wall and the outer tube wall.

19. The aerosol generating device according to claim 18, wherein an air dielectric layer is formed between the inner tube wall of the heat insulator and the infrared emitter.

20. The aerosol generating device according to claim 17, wherein the infrared emitter comprises a first end and a second end which are opposite along the length direction;
the housing is provided therein with a second support that supports or holds the infrared emitter at the first end or the second end; and
the second support further comprises a first boss configured for abutting against the infrared emitter and a second boss configured for abutting against the heat insulator, the first boss and the second boss are arranged from inside to outside in the radial direction.
